(19) United States
(12) Patent Application Publication
(10) Pub. No.: US 2002/0078276 A1
(43) Pub. Date: Jun. 20, 2002

(54) RAID controller with IDE interfaces

(76) Inventor: Ming-Li Hung, Taipei (TW)

Correspondence Address: DELLETT AND WALTERS, 310 S.W. FOURTH AVENUE, SUITE 1101, PORTLAND, OR, 97204, US

(21) Appl. No.: 09/952,606

(22) Filed: Sep. 13, 2001

(30) Foreign Application Priority Data
Dec. 20, 2000 (TW) 089222113

(51) Int. Cl. G06F 13/10

(52) U.S. Cl. 710/74

(57) ABSTRACT

A RAID controller has a host IDE interface and a disk array IDE interface respectively adapted to connect to a host system and a disk array. Both the specifications of the IDE interfaces are chosen as parallel transmission mode or series transmission mode. The RAID controller further has a CPU, a process control unit, a buffer memory unit and a program memory unit, wherein the program memory unit is stored with programs and commands to implement RAID level 3, level 4, level 5 and level 6 technology so as to control the process control unit to process data stored in the buffer memory unit.

### BACKGROUND OF THE INVENTION

1. Field of the Invention

The present invention pertains to a redundant array of inexpensive disks (RAID) controller, in particular, a RAID controller with IDE interface technology for data transmission between a host system and a disk array system formed by multiple storage disks.

2. Description of Related Art

In accordance with the popularization of the Internet, more information is easily gathered than before. Thus how to effectively, quickly and safely store such gathered information becomes an essential consideration. Therefore, a popular solution to these storage demands for increasing capacity and reliability is the use of multiple smaller storage modules configured in geometries that permit redundancy of stored data to assure data integrity in case of a system failure.

A storage system called RAID has been designed to provide large amounts of data storage capacity, data redundancy for reliability, and fast access to stored data, wherein the RAID technology is published by David A. Patterson, et al., from the University of California at Berkeley entitled “A Case for Redundant Arrays of Inexpensive Disks (RAID)”. RAID provides data redundancy to recover data from a failed disk drive and thereby improve reliability of the disk array. Now, RAID technology already has been developed to seven levels (level 0 to level 6) as defined by the RAID Advisory Board (RAB). Thus based on the seven different levels (level 0 to level 6), a RAID controller is designed to implement those RAID levels.

With reference to FIG. 3, a block diagram of a RAID storage system is shown, wherein a RAID controller (100) is provided between a host system (200) and a disk array configured by a disk 1 (101) and a disk 2 (102). Because the RAID controller (100) functions the data transmission between the host system (200) and the disk array, the interface standard between the RAID controller (100) and the host system (200) and the interface standard between the RAID controller (100) and the disk array both need to be determined. Conventionally, the interface standard between the RAID controller (100) and the host system (200) is chosen from the Small Computer Systems Interface (SCSI), Fiber Channel (FC), Peripheral Component Interconnect (PCI), Micro Channel (MC), Serial Storage Architecture (SSA) or Integrated Drive Electronic (IDE) group.

The interface standard between the RAID controller (100) and the disk array is chosen from the IDE, SCSI, SSA or FC group. Mostly, the interface standard configuration among the host system (200), the RAID controller (100) and the disk array is chosen as SCSI-RAID-SCSI, FC-RAID-SCSI, or PCI-RAID-SCSI.

An exact and specific wording for IDE is called “ATA” or “ATAPI” (At Attachment with Packet Interface), IDE is just a general statement.

The IDE interface is the most popular interface applied between a host system and hard disks in personal computers. Thus the IDE disks dominate most markets. Due to the wide popularity of the IDE disk, its price is greatly lower than the price of other storage devices having non-IDE interfaces.

Moreover, the IDE(ATA) interface is now the standard equipment operating between the personal computers and hard disks, and is supported by most operation systems (OS). Thus, users do not need to worry about any problems concerning driver programs when installing the driver program of a RAID controller in the computer.

The ATA interface has two different data transmission modes, namely the parallel ATA mode and the series ATA mode. The data transmission speed of parallel ATA has reached 100 MB/sec, and now the personal computer at least has two IDE interfaces, so the total data transmission speed has reached 200 MB/sec and that is faster than the speed of a single channel of SCSI interface (ULTRA160, 160 MB/sec). In the future, the transmission speed of ATA will be able to reach 1.5 Gbits/sec, 3 Gbits/sec or 6 Gbits/sec.

Conventionally, the operation process of a RAID controller is implemented by a central-processor unit in a personal computer, hence there is no need to equip the computer with an extra RAID controller and so costs are reduced, however the performance of the central-processor unit is also reduced.

Further, a conventional RAID controller with an IDE-RAID-IDE interface configuration only supports RAID level 0 and level 1, and can not support RAID level 3, level 4, level 5 or level 6. RAID level 0 has the function to improve the performance but can not provide “fault tolerance”, thus the reliability of the RAID controller is not high. Although RAID level 1 provides “fault tolerance”, the disk array must have a high capacity to implement the “fault tolerance” function, thus the total cost is high.

### SUMMARY OF THF INVENTION

The main object of the present invention is to provide a RAID controller with IDE interfaces, which is provided between a host system and a disk array, and supports RAID level 3, level 4, level 5 and level 6.

To achieve the object of the invention, the RAID controller mainly comprises a central-processing unit (CPU) and a memory unit. The CPU is connected to the host system to access data via IDE interface. Several TDE interface channels are provided between the RAID controller and the disk array to enhance the performance of data transmission, wherein the memory unit provides a buffer or a cache function.

The CPU in the RAID controller is designed to receive and decode commands from the host system via the IDE interface, and/or to distribute data received from the host system into the disk array. Moreover, the CPU is able to read data stored in the disk array, check whether the data is defective or not, and restore defective data if necessary, and then transmit data back to the host system.

Other objects, advantages, and novel features will become more apparent from the following detailed description when taken in conjunction with the attached drawings.

### BRIEF DESCRIPTION OF THE DRAWINGS

FIG. 1 is a block diagram showing a RAID controller in accordance with the present invention provided between a host system and a disk array;

FIG. 2 shows a detailed block diagram of the RAID controller in FIG. 1, and

FIG. 3 is a block diagram showing a conventional RAID controller provided between a host system and a disk array.

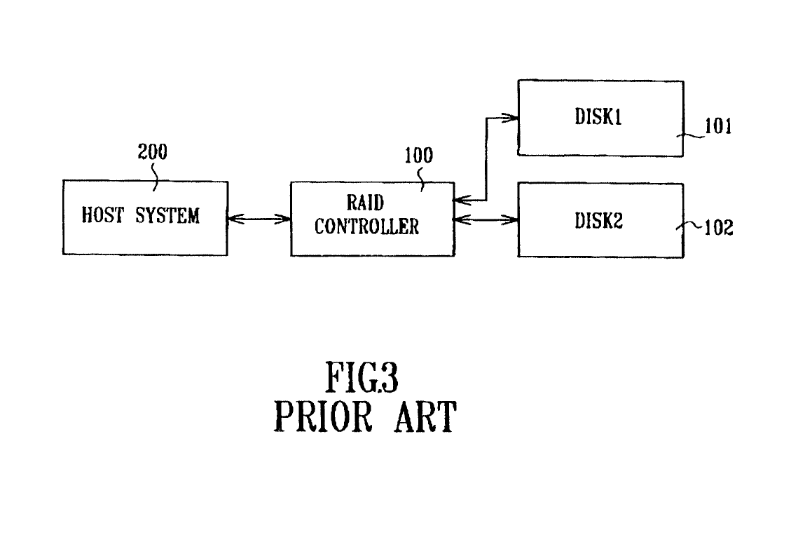

### DETAILED DESCRIPTION OF THE PREFERRED EMBODIMENT

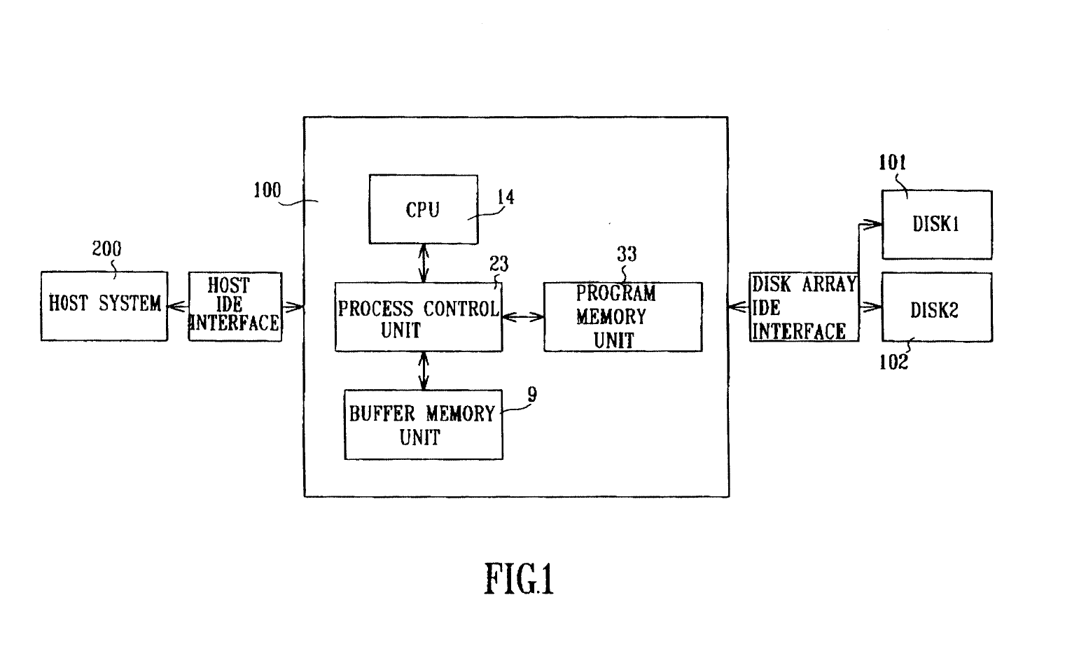

With reference to FIG. 1, there is shown a main structure of a RAID controller (100) in combination with a host system (200) and a disk array, wherein the RAID controller (100) comprises a central-processing unit (CPU) (14), a process control unit (23), a buffer memory unit (9) and a program memory unit (33). The RAID controller (100) is connected to the host system (200) via a host IDE interface, and a disk array IDE interface is also provided between the RAID controller (100) and a disk array composed of a disk 1 (101) and a disk 2 (102). The program memory unit (33) is stored with programs and commands to implement RAID level 3, level 4, level 5 and level 6 technology so as to control the process control unit (23). In this embodiment, a read-only memory (ROM) is chosen as the program memory unit (33).

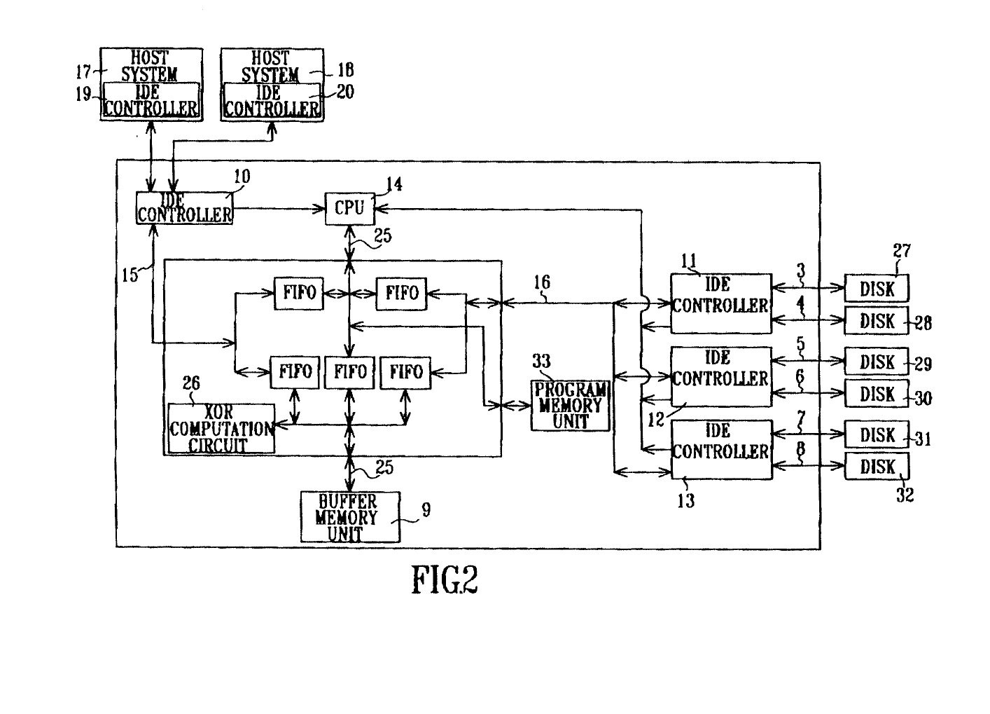

With reference to FIG. 2, the detailed block diagram of the RAID controller (100) is shown. The RAID controller (100) is connected to host systems (17,18) and a disk array composed of disks (27 to 32) via the IDE interfaces respectively.

The RAID controller (100) receives data from the host systems (17,18) through IDE buses (1, 2), and processes data by the CPU (14). Then the data is stored in the buffer memory unit (9) or distributed into the disks (27 to 32) through IDE controllers (11 to 13) and IDE buses (3 to 8) by the process control unit (23).

In the following description, the data write/read modes will be clearly disclosed.

In the data write mode:

The host systems (17,18) send out a write command through the IDE controllers (19, 20) of the host systems (17, 18) and the IDE buses (1, 2) into an IDE controller (10) of the RAID controller (100), whereby the IDE controller (10) sends out an interrupt command (21) to enable the CPU (14).

When the CPU (14) is enabled by the interrupt command (21) and the IDE controller (10) has received the write command and data parameters, such as data size, the IDE controller (10) controls the process control unit (23) to enable a PCI bus (15) that is connected between the IDE controller (10) and the process control unit (23). Then the data is transmitted from the host systems (17,18) through the IDE controllers (19,20,) the IDE buses (1,2), the IDE controller (10), PCI bus (15) and RAM bus (25) into the buffer memory unit (9). When the data is transmitted into the buffer memory unit (9), the CPU (14) immediately responds to the host systems (17,18) that the “data write” is accomplished.

The data stored in the buffer memory unit (9) is further transmitted to and processed by the RAID level 3, level 4 and level 5 programs stored in the program memory unit (33). Then the processed data is calculated to find redundant data by an exclusive OR (XOR) computation circuit (26) in the process control unit (23) and is rewritten into the buffer memory unit (9).

The CPU (14) determines how to distribute the data stored in the buffer memory unit (9) into the disks (27 to 32) according to the RAID level in the program memory unit (33). Finally, the data stored in the buffer memory unit (9) is sequentially transmitted from the buffer memory unit (9), the RAM bus (25), the process control unit (23), the PCI bus (16), the IDE controllers (11 to 13), the IDE buses (3 to 8) into each disk (27 to 32).

In the data read mode:

The host systems (17,18) send out a read command through the IDE controllers (19,20) and the IDE buses (1,2) into the IDE controller (10), whereby the IDE controller (10) sends out an interrupt command (21) to enable the CPU (14).

When the CPU (14) is enabled by the interrupt command (21) and the IDE controller (10) has received the read command and data parameters, such as the position in which the data is stored, the CPU (14) detects whether the data has been restored in the buffer memory unit (9) or not. If the data has been restored in the buffer memory unit (9), the IDE controller (10) sends out a control command to the process control unit (23) to enable the PCI bus (15), thus the data in the buffer memory unit (9) is transmitted to the host systems (17,18) through the PCI bus (15).

On the contrary, if the data is not in the buffer memory unit (9), the read command is sent to the disks (27 to 32) through the process control unit (23), the PCI bus (16), the IDE controllers (11 to 13) and the IDE buses (3 to 8). Then the data in the disks (27 to 32) is transmitted through IDE buses (3 to 8), the IDE controllers (11 to 13), the PCI bus (16), the process control unit (23) and the RAM bus (25) into the buffer memory unit (9). Then the XOR computation circuit (26) computes the data whether the data in the buffer memory unit (9) is redundant data and further checks whether the data is defective. If the data is correct, the data in the buffer memory unit (9) is transmitted into the host systems (17,18).

Although the present invention has been explained in relation to its preferred embodiment, it is to be understood that many other possible modifications and variations can be made without departing from the spirit and scope of the invention as hereinafter claimed.

What is claimed is:

1. A RAID controller comprising:
a host IDE interface adapted to be connected to a host system;
a disk array IDE interface adapted to be connected to a disk array;
a central processing unit (CPU) connected with the host IDE interface and the disk array IDE interface to respond to interrupt commands from the host IDE interface and the disk array IDE interface so as to execute data read/write commands;
a buffer memory unit connected with the CPU to temporarily store data;
a process control unit connected with the CPU to control channels connected between the buffer memory unit and the host system, and channels connected between the buffer memory unit and the disk array; and
a program memory unit stored with programs to implement RAID level 3, level 4, level 5 and level 6 technology so as to control the process control unit to process the data in the buffer memory unit to be transmitted into the host system or to be distributed into the disk array.

2. The RAID controller as claimed in claim 1, wherein the process control unit comprises an XOR computation circuit for data computing.

3. The RAID controller as claimed in claim 1, wherein both the host IDE interface and the disk array IDE interface comprise IDE controllers.

4. The RAID controller as claimed in claim 1, wherein the program memory unit is a read-only memory (ROM).
